(19) United States
(12) Patent Application Publication
(10) Pub. No.: US 2011/0084822 A1
(43) Pub. Date: Apr. 14, 2011

(54) DETECTING APPARATUS FOR A BICYCLE

(76) Inventor: Johnson Li, Taichung Hsien (TW)

(21) Appl. No.: 12/576,251

(22) Filed: Oct. 9, 2009

(51) Int. Cl. B62J 6/00; B60Q 1/00; G08B 21/00

(52) U.S. Cl. 340/432; 340/539.1; 340/670; 340/441

(57) ABSTRACT

A detecting apparatus for a bicycle includes a detector mounted on a wheel fork and a monitoring device connected to a bicycle for immediately monitoring cycling status data. The detector wirelessly communicates with the monitoring device for detecting a wheel rotation rate. The monitoring device includes a process unit controlling the monitoring device and calculating a bicycle speed from the wheel rotation rate. A display module is electrically connected to the process unit. The display module has a speed display mode for displaying the bicycle speed.

### BACKGROUND OF THE INVENTION

1. Field of the Invention

The present invention relates to a detecting apparatus for a bicycle, and more particularly to a detecting apparatus provided for immediately monitoring a cycling status.

2. Description of Related Art

A conventional electronic device for a bicycle in accordance with the prior art comprises a case containing a micro-processor electronically connected to a movement sensor via a cable. The movement sensor is associated with a wheel of the bicycle. A display device mounted on the case is provided for displaying the information. At least one control key is disposed on the case and relates to the information processed by the micro-processor. The control key is constituted by at least one part of an upper side of a cover of the case. The cover is pivotally mounted on a bottom of the case. The cover includes devices for emitting sound signals respectively corresponding to the nature of the magnitudes appearing in the display device and seen through a window of the case.

However, the movement sensor does not communicate wirelessly with the micro-processor. A rider has to carefully prevent from pulling the cable apart from the case or the movement sensor. The electronic device does not have any alarm device to warn the rider when the speed of the bicycle is too fast. Therefore, the electronic device for a bicycle is inconvenient and unsafe.

The present invention has arisen to mitigate and/or obviate the disadvantages of the conventional electronic device for a bicycle.

### SUMMARY OF THE INVENTION

The main objective of the present invention is to provide an improved detecting apparatus for a bicycle.

To achieve the objective, a detecting apparatus for a bicycle in accordance with the present invention comprises a detector adapting to be mounted on a wheel fork of a bicycle. The detector is an infrared detector for emitting and detecting infrared radiation. The detector adapts to emit infrared radiation toward a plurality of wheel spokes. When the wheel spokes rotate and determine a cut-off frequency, the detector receives infrared radiation in the cut-off frequency to calculate the wheel rotation rate.

The detector comprises a detecting unit for sensing infrared radiation and calculating the wheel rotation rate. A transformation unit is electrically connected to the detecting unit for transforming the wheel rotation rate into signals. The detector comprises a transmission unit electrically connected to the transformation unit for wirelessly sending signals.

The detecting apparatus for a bicycle further comprises a monitoring device wirelessly communicating with the detector. The monitoring device adapts to be mounted on the bicycle for immediately monitoring cycling status data. The monitoring device comprises a signal-receiving unit wirelessly communicating with the transmission unit for receiving signals sent from the detector. A process unit is electrically connected to the signal-receiving unit for processing signals and transforming signals into a bicycle speed, a traveled distance, and a cycling time. A buzzer is electrically connected to the process unit. When the process unit sends an alert order to the buzzer, the buzzer gives a warning sound.

The monitoring device comprises a display module electrically connected to the process unit for displaying the cycling status calculated by the process unit. The display module is a backlight module with different colors. The display module is able to display the bicycle speed in a speed display mode, the traveled distance in a distance display mode, the cycling time in a time display mode, a power status of the detector and the monitoring device in a power status display mode.

Moreover, the monitoring device has a control interface electrically connected to the process unit for controlling and setting data. The control interface includes a switch provided for switching the display modes from one mode to another in the display module. The control interface includes an input unit provided for inputting and setting data into the process unit. The input unit has a speed button provided for setting a desired speed range, a distance button provided for setting a desired distance range, a time button provided for setting a desired time range and a backlight button provided for switching on/off the display module and switching the display module to light in a time period. Accordingly, when the bicycle speed, the traveled distance or the cycling time is out of the desired range, the process unit sends the alert order to the buzzer to give the warning sound.

In accordance with a second aspect of the present invention, the detector includes a reflector adapting to be connected to a wheel rim for reflecting infrared radiation emitted from the detector. When the reflector rotates with the wheel rim and passes the detector to reflect infrared radiation, the detector sequentially receives the reflected infrared radiation to calculate the wheel rotation rate.

Further benefits and advantages of the present invention will become apparent after a careful reading of the detailed description with appropriate reference to the accompanying drawings.

### BRIEF DESCRIPTION OF THE DRAWINGS

FIG. 1 is a block diagram of a preferred embodiment of a detecting apparatus for a bicycle in accordance with the present invention;

FIG. 2 is a perspective view of the preferred embodiment of the detecting apparatus for a bicycle in accordance with the present invention as the detecting apparatus is mounted on a bicycle;

FIG. 3 is a plane view of the preferred embodiment of the detecting apparatus for a bicycle in accordance with the present invention as the detecting apparatus is mounted on the bicycle;

FIG. 4 is a plane view of the preferred embodiment of the detecting apparatus for a bicycle in accordance with the present invention as the detector is mounted on a wheel fork;

FIG. 5 is a perspective view of a second embodiment of the detecting apparatus for a bicycle in accordance with the present invention as the detecting apparatus is mounted on the bicycle;

FIG. 6 is a plane view of the second embodiment of the detecting apparatus for a bicycle in accordance with the present invention as the detecting apparatus is mounted on the bicycle; and

FIG. 7 is a block diagram of a third embodiment of the detecting apparatus for a bicycle in accordance with the present invention.

### DETAILED DESCRIPTION OF THE INVENTION

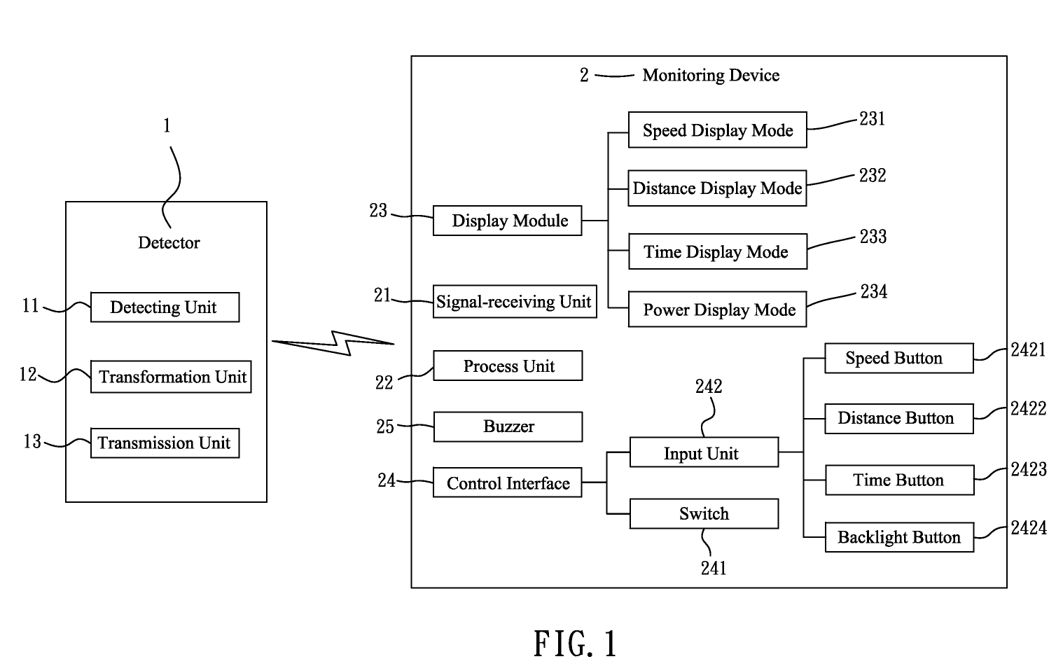

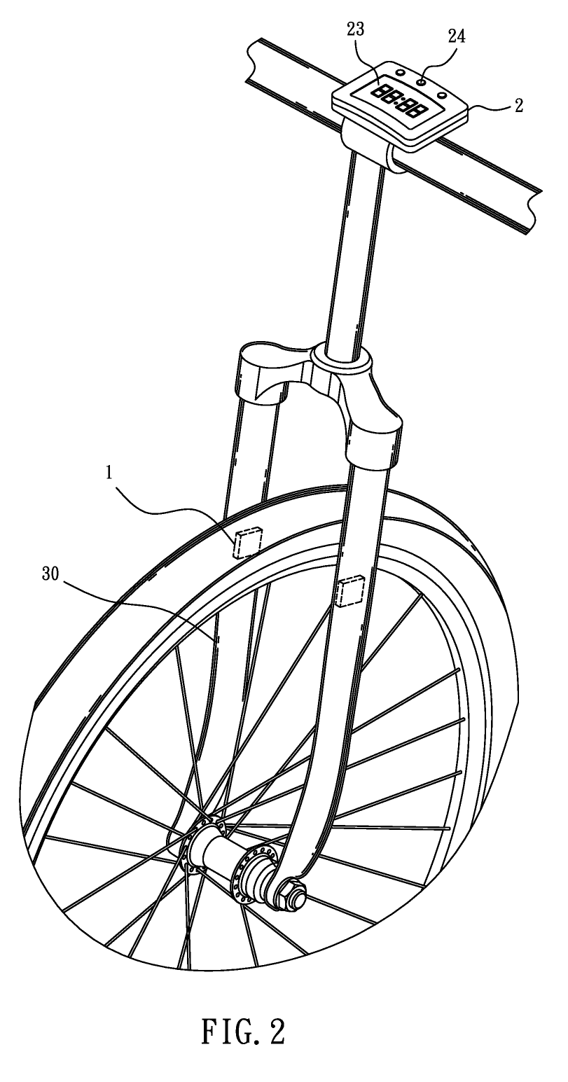

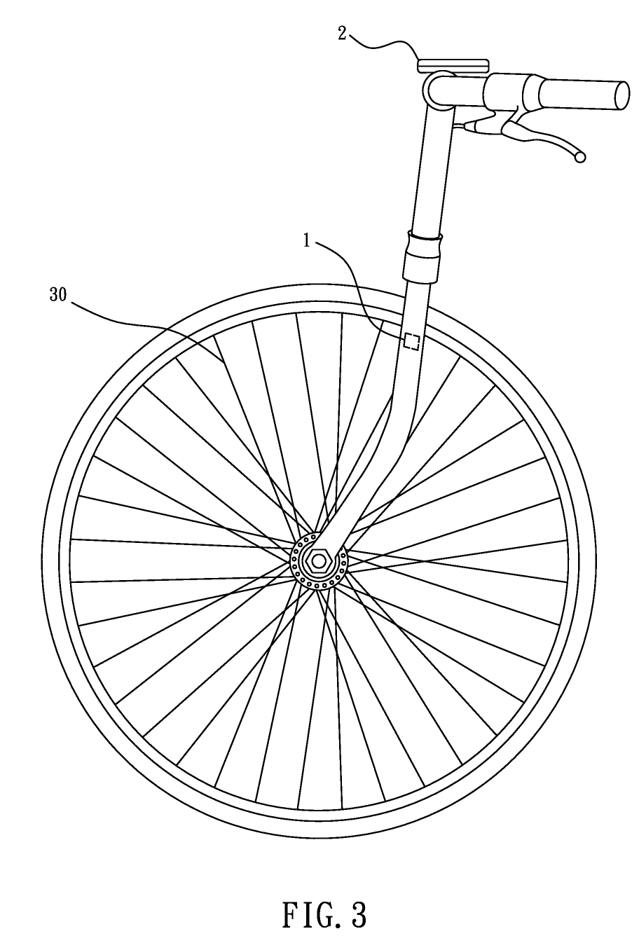

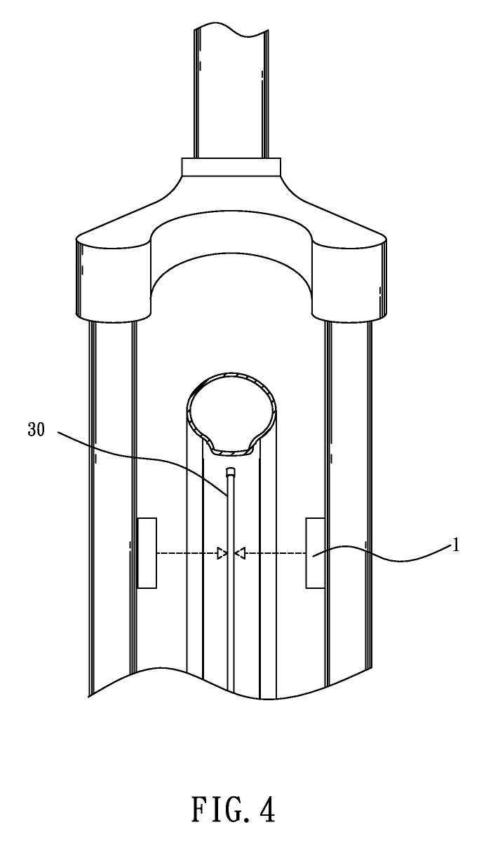

Referring to the drawings and initially to FIGS. 1-4, a detecting apparatus for a bicycle in accordance with the present invention comprises a detector 1 adapting to be mounted on a wheel fork (not numbered) of a bicycle. In this embodiment, the detector 1 is an infrared detector for emitting and detecting infrared radiation. The detector 1 emits infrared radiation toward a plurality of wheel spokes 30. When the wheel spokes 30 rotate and determine a cut-off frequency, the detector 1 receives infrared radiation in the cut-off frequency to calculate a wheel rotation rate.

The detector 1 comprises a detecting unit 11 for sensing infrared radiation and calculating the wheel rotation rate. A transformation unit 12 is electrically connected to the detecting unit 11 for transforming the wheel rotation rate calculated by the detecting unit 11 into signals. The detector 1 comprises a transmission unit 13 electrically connected to the transformation unit 12 for wirelessly sending signals.

The detecting apparatus for a bicycle according to the present invention comprises a monitoring device 2 wirelessly communicating with the detector 1. The monitoring device 2 adapts to be mounted on the bicycle for immediately monitoring cycling status data. The monitoring device 2 comprises a signal-receiving unit 21 wirelessly communicating with the transmission unit 13 for receiving signals sent from the detector 1. A process unit 22 is electrically connected to the signal-receiving unit 21 for processing signals and transforming signals into a bicycle speed, a traveled distance, and a cycling time. A buzzer 25 is electrically connected to the process unit 22. When the process unit 22 sends an alert order to the buzzer 25, the buzzer 25 gives a warning sound. The buzzer 25 is able to be switched to a mute mode.

The monitoring device 2 comprises a display module 23 electrically connected to the process unit 22 for displaying the cycling status calculated by the process unit 22. The display module 23 is a backlight module with different colors. When the process unit 22 sends the alert order to the display unit 23, the display unit 23 changes emitted light color to red or changes to flash light for giving a warning light. The display module 23 is able to display the bicycle speed in a speed display mode 231, the traveled distance in a distance display mode 232, the cycling time in a time display mode 233, a power status of the detector 1 and the monitoring device 2 in a power status display mode 234.

Moreover, the monitoring device 2 has a control interface 24 electrically connected to the process unit 22 for controlling and setting the data. The control interface 24 includes a switch 241 provided for switching the display modes from one mode to another in the display module 23. The control interface 24 includes an input unit 242 provided for manually inputting and setting data into the process unit 22. The input unit 242 has a speed button 2421 provided for setting a desired speed range, a distance button 2422 provided for setting a desired distance range, a time button 2423 provided for setting a desired time range and a backlight button 2424 provided for switching on/off the display module 23 and switching the display module 23 to light in a time period.

Accordingly, when the display module 23 is directed to the speed display mode 231, a rider is able to set the desired speed range via the speed button 2421. As the bicycle speed is out of the desired speed range, the process unit 22 sends the alert order to the buzzer 25 and the display module 23 to give the warning sound and light respectively.

When the display module 23 is directed to the distance display mode 232, the rider is able to set the desired distance range via the distance button 2422. As the traveled distance is out of the desired distance range, the process unit 22 sends the alert order to the buzzer 25 and the display module 23 to give the warning sound and light respectively.

When the display module 23 is directed to the time display mode 233, the rider is able to set the desired time range via the time button 2423. As the cycling time is out of the desired time range, the process unit 22 sends the alert order to the buzzer 25 and the display module 23 to give the warning sound and light respectively.

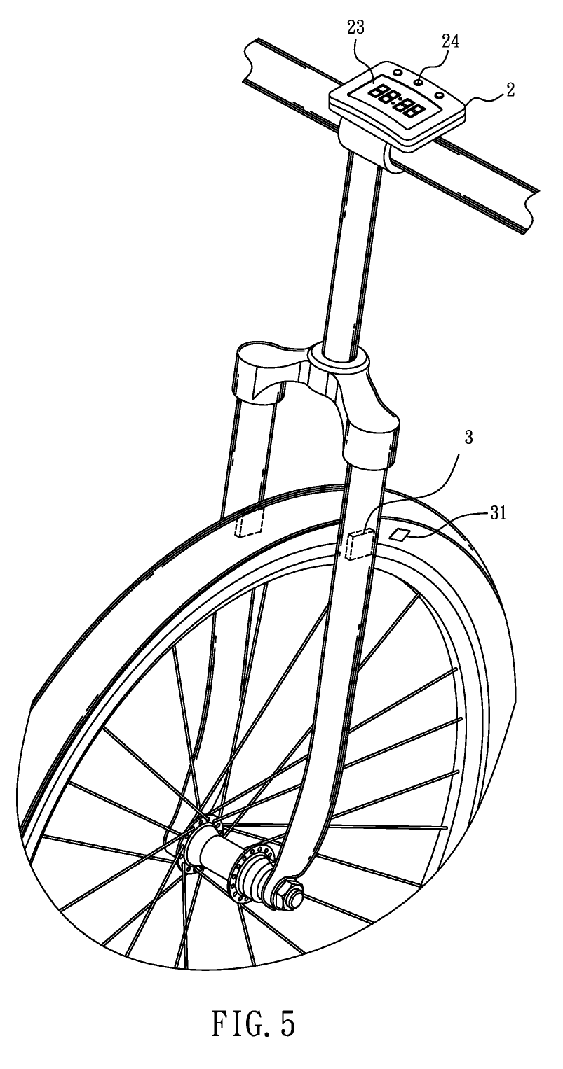

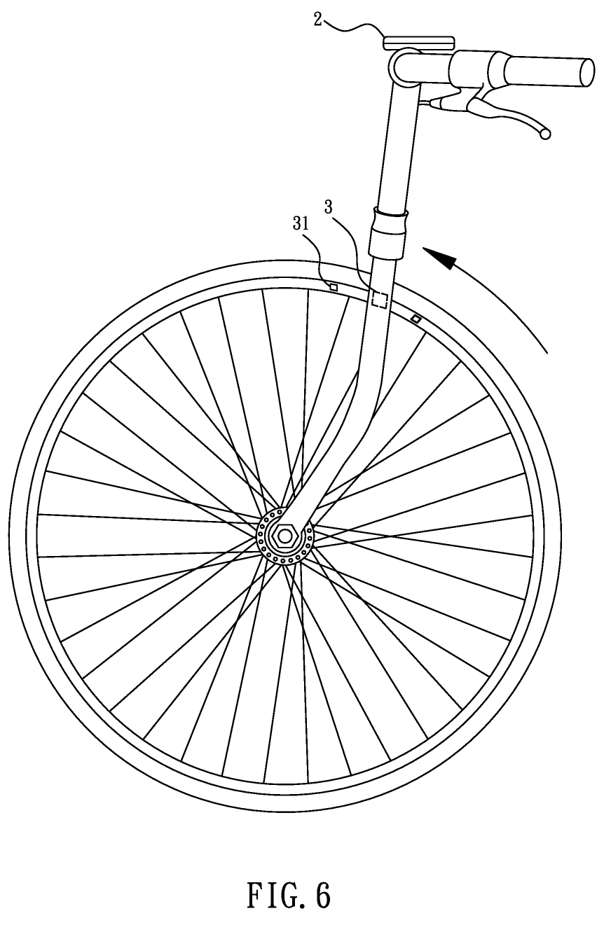

With reference to FIGS. 5 and 6, that shows a second embodiment of the detecting apparatus for a bicycle in accordance with the present invention. The elements and effects of the second embodiment which are the same with the first embodiment are not described, only the differences are described. In this embodiment, the detector 3 includes a reflector 31 adapting to be connected to a wheel rim for reflecting infrared radiation emitted from the detector 3. The reflector 31 and the detector 3 are in a face-to-face relation. When the reflector 31 rotates with the wheel rim and passes the detector 3 to reflect infrared radiation, the detector 3 sequentially receives the reflected infrared radiation to calculate the wheel rotation rate.

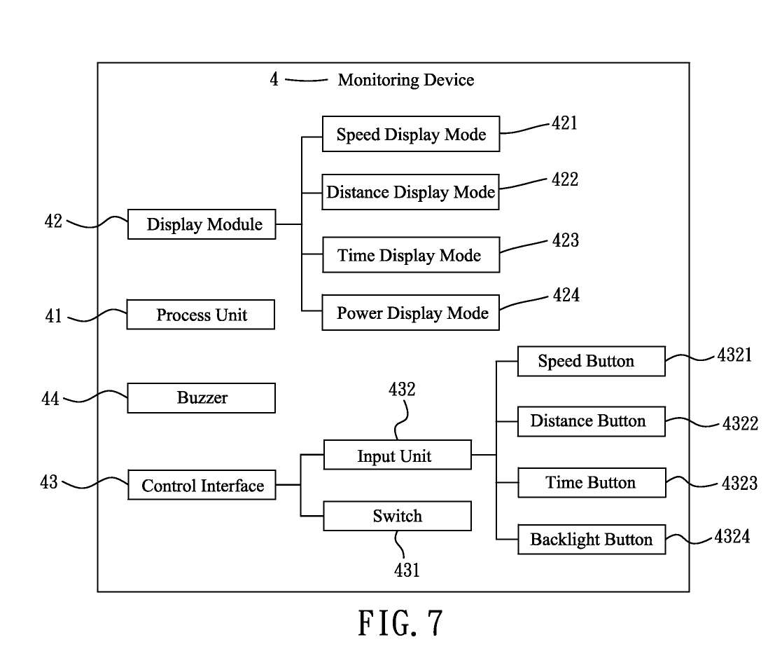

With reference to FIG. 7, that shows a third embodiment of the detecting apparatus for a bicycle in accordance with the present invention. The elements and effects of the third embodiment which are the same with the first embodiment are not described, only the differences are described. In the third embodiment, the detecting apparatus for a bicycle comprises a monitoring device 4 adapting to be mounted on a bicycle for immediately monitoring cycling status data. A Globe Positioning System (GPS) is applied to the detecting apparatus for a bicycle, such that the GPS detects the bicycle speed, the traveled distance, and the cycling time and transmits to the monitoring device 4.

The monitoring device comprises a process unit 41 for controlling the monitoring device 4 and processing the data. A buzzer 44 is electrically connected to the process unit 41. When the process unit 41 sends an alert order to the buzzer 44, the buzzer 44 gives a warning sound. A display module 42 is electrically connected to the process unit 41 for displaying the data. The display module 42 is able to display the bicycle speed in a speed display mode 421, the traveled distance in a distance display mode 422, the cycling time in a time display mode 423, a power status of the monitoring device 4 in a power status display mode 424.

Moreover, the monitoring device 4 comprises a control interface 43 electrically connected to the process unit 41 for controlling data in the process unit 41. The control interface 43 includes a switch 431 provided for switching from one mode to another in the display module 42. The control interface 43 includes an input unit 432 provided for manually inputting and controlling data into the process unit 41. The input unit 432 has a speed button 4321 provided for setting a desired speed range, a distance button 4322 provided for setting a desired distance range, a time button 4323 provided for setting a desired time range, and a backlight button 4324 provided for switching on/off the display module 42 and switching the display module 42 to light in a time period.

Although the invention has been explained in relation to its preferred embodiment, it is to be understood that many other possible modifications and variations can be made without departing from the spirit and scope of the invention as hereinafter claimed.

What is claimed is:

1. A detecting apparatus for a bicycle comprising:
a monitoring device adapting to be connected to a bicycle for immediately monitoring a cycling status, the monitoring device comprising:
a process unit controlling the monitoring device for calculating bicycle status data; and
a display module electrically connected to the process unit, the display module having a speed display mode for displaying a bicycle speed.

2. The detecting apparatus for a bicycle as claimed in claim 1 further comprising a detector wirelessly communicating with the monitoring device and adapting to be mounted on a wheel fork of the bicycle for detecting a wheel rotation rate, the detector comprising:
a detecting unit provided for sensing the wheel rotation rate;
a transformation unit electrically connected to the detecting unit for transforming the wheel rotation rate into signals; and
a transmission unit electrically connected to the transformation unit for wirelessly sending signals to the monitoring device;
the monitoring device comprising a signal-receiving unit electrically connected to the process unit for wirelessly receiving signals sent from the transmission unit.

3. The detecting apparatus for a bicycle as claimed in claim 2, wherein the monitoring device comprises a buzzer electrically connected to the process unit for giving an alert sound, the monitoring device comprising a control interface electrically connected to the process unit for controlling the process unit to set the data, the control interface having an input unit for manually inputting data, the input unit having a speed button for setting a desired speed range, wherein when the bicycle speed is out of the desired speed range, the buzzer gives an alert sound.

4. The detecting apparatus for a bicycle as claimed in claim 2, wherein the display module has a power status display mode for displaying power statuses of the monitoring device and the detector.

5. The detecting apparatus for a bicycle as claimed in claim 2, wherein the detector is an infrared detector for emitting and detecting infrared radiation, the detector emitting infrared radiation toward a plurality of wheel spokes, the wheel spokes rotating to determine a cut-off frequency, such that the detector receives infrared radiation in the cut-off frequency to calculate the wheel rotation rate.

6. The detecting apparatus for a bicycle as claimed in claim 2, wherein the detector is an infrared detector for emitting and detecting infrared radiation, the detector including a reflector adapting to be connected to a wheel rim for reflecting infrared radiation emitted from the detector, wherein when the reflector rotates with the wheel rim and passes the detector, the detector receives infrared radiation reflected from the reflector to calculate the wheel rotation rate.

7. The detecting apparatus for a bicycle as claimed in claim 3, wherein the display module has a distance display mode for displaying a traveled distance calculated by the process unit, the input unit having a distance button for setting a desired distance range, wherein when the traveled distance is out of the desired distance range, the buzzer gives the alert sound.

8. The detecting apparatus for a bicycle as claimed in claim 3, wherein the display module is a backlight module with different colors, the input unit having a backlight button for switching on/off the display module and switching the display module to light in a time period.

9. The detecting apparatus for a bicycle as claimed in claim 3, wherein the display module has a time display mode provided for displaying a cycling time sent from the process unit, the input unit having a time button for setting a desired time range, wherein when the cycling time is out of the desired time range, the buzzer gives the alert sound.
